(19) United States
(12) Patent Application Publication
(10) Pub. No.: US 2012/0323658 A1
(43) Pub. Date: Dec. 20, 2012

(54) SYSTEMS AND METHODS FOR PROVIDING DISCOUNT OFFERS VIA AN INTERNET DIRECTORY INTERFACE

(76) Inventors: Dylan T. X ZHOU, San Gabriel, CA (US); Andrew H.B ZHOU, Tiburon, CA (US); Tiger ZHOU, Tiburon, CA (US)

(21) Appl. No.: 13/161,501

(22) Filed: Jun. 16, 2011

(51) Int. Cl. G06Q 30/00

(52) U.S. Cl. 705/14.23; 705/14.39

(57) ABSTRACT

Embodiments of computer implemented systems and methods for providing discount offers via an internet directory interface are described. One example method includes receiving, from a user, via a user interface, a request to search for one or more discount offers associated with a product, the request being associated with search criteria, facilitating the search for the one or more discount offers through an integrated search engine based on the search criteria, providing search results, the search results including one or more discount offers for the one or more products, receiving, from the user, a selection of a product from the search results, the selection of the product including a product quantity, and providing the user with a specific discount offer for the product based on the selection. The method may further include providing a payment functionality to process a transaction associated with a purchase of the product with the specific discount from a merchant associated with the product, the payment functionality including one or more means of payment. The method may further include sending voucher codes to the user and the merchant.

### FIELD

This application relates generally to data processing, and more specifically to systems and methods for providing discount offers via an internet directory interface.

### BACKGROUND

The rise of the Internet resulted in proliferation of online coupons. An online coupon can be exchanged for a financial discount or rebate when purchasing a product online or at a “brick and mortar” store. Such coupons are widely distributed through the Internet and mobile devices such as cell phones. In addition, online coupons can also be targeted selectively to regional markets in which price competition is great. Online retailers often refer to coupons as voucher codes and discount vouchers. Online coupons can provide for reduced cost or free shipping, a specific dollar or percentage discount, or some other offer to encourage consumers to purchase specific products or to purchase from specific retailers. Because paper coupons would be difficult to redeem, typically secret words or codes are distributed for consumers to type in at checkout. Marketers can use different codes for different channels our groups in order to distinguish response rates.

However, the existing solutions do not allow Internet coupon distributors to provide wholesale, retail, local, and reward coupons within a single internet directory interface in combination with a search engine and the ability to compare and buy products and services from various merchants.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

A method for providing discount offers via an internet directory interface includes receiving, from a user, via a user interface, a request to search for one or more discount offers associated with a product, the request being associated with search criteria, facilitating the search for the one or more discount offers through an integrated search engine based on the search criteria, providing search results, the search results including one or more discount offers for the one or more products, receiving, from the user, a selection of a product from the search results, the selection of the product including a product quantity, and based on the selection, providing the user with a specific discount offer for the product.

The method may further provide a payment functionality to process a transaction associated with a purchase of the product with the specific discount from a merchant associated with the product. The payment functionality including one or more means of payment. The method may further include sending voucher codes to the user and the merchant. The method may further include comprising providing an escrow to hold funds until a delivery of the product is confirmed, the funds being delivered to the merchant upon the confirmation. The method may further specify specifying a processing time associated with the transaction. The method may further comprise providing merchant information associated with the merchant. The merchant information may include a name, a location, reputation, transaction history, and contact information.

The user may select a type of the discount, the type such as a wholesale discount, a local discount, a retail discount, and a reward coupon. The method may further enable a comparison between comparing values from various merchants. The method may further provide information associated with the specific discount. The information may include a value, a product quantity, an image, a video, or a price per unit, a countdown counter showing a time left to an expiration of the specific discount, and payment information. The price per unit may depend on the quantity of the product. The method may further provide a subscription to daily discount offers.

In further exemplary embodiments, modules, subsystems, or devices can be adapted to perform the recited steps. Other features and exemplary embodiments are described below.

### BRIEF DESCRIPTION OF DRAWINGS

Embodiments are illustrated by way of example and not limitation in the figures of the accompanying drawings, in which like references indicate similar elements and in which:

FIG. 1 is a block diagram showing an architecture within which systems and methods for providing discount offers via an internet directory interface can be implemented, in accordance with an example embodiment.

FIG. 2 is a block diagram showing a discount offers engine, in accordance with an example embodiment.

FIG. 3 is a screenshot of an internet directory interface, in accordance with an example embodiment.

FIG. 4 is a flow chart illustrating a method for providing discount offers via an internet directory interface, in accordance with an example embodiment.

FIG. 5 is a diagrammatic representation illustrating an example machine in the form of a computer system within which a set of instructions, for causing the machine to perform any one or more of the methodologies discussed herein, may be executed.

### DETAILED DESCRIPTION

Systems and methods for providing discounts via an internet directory interface may provide wholesale, retail, local, and reward coupons within a single internet directory interface in combination with a search engine and the ability to compare and buy products and services from various merchants.

An example method for providing discounts via an internet directory interface may facilitate a fast and convenient search for various types of discounts such as wholesale, retail, local, and reward coupons via an internet directory interface. Users, depending on whether they are buyers or merchants may utilize different versions of the interface. For example, buyers can utilize the internet directory interface to search for products and services. They can log into the interface, select the wholesale coupon option, specify search criteria and obtain coupon offers associated with wholesale products and services based on the search criteria.

When buyers select specific products or services from the search results, they are directed to a specific webpage having information associated with the selected product or service. The information may include a retail value, product quantity and the price. The price per unit may depend on the quantity selected. For example, higher quantity may result in lower price per unit. The information may also include a countdown counter showing the time left to complete the discounted transaction.

A buyer area within the webpage may show information related to the buyer such as the identity and quantity of the goods and services selected for purchase. The webpage may also provide educational materials on how to search and select the products as well as the information on how a merchant can be paid.

Once a transaction is finalized, the backend processor may process the transaction and send voucher codes to the merchant and the buyer who are the parties to the transaction. Methods for providing retail, local, and reward coupons may be implemented similar to the wholesale method described above.

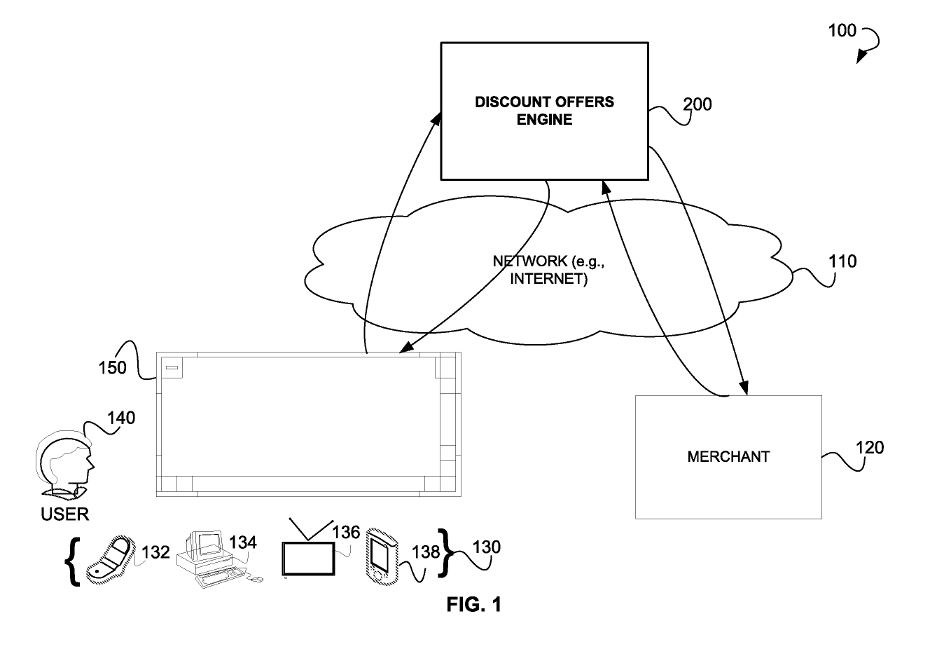

FIG. 1 shows an architecture 100 within which systems and methods for providing discount offers via an internet directory interface can be implemented. The architecture 100 may include a network 110, a merchant 120, client devices 130, a user 140, an internet directory interface 150, and a discount offers engine 200. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 120 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may be a network of data processing nodes that are interconnected for the purpose of data communication.

The merchant 120 may represent a seller who is selling goods or services online in real-time, without an intermediary service, over the Internet. To facilitate commercial transaction, the merchant 120 may have an online store. Online retailers may offer various discounts referred to as coupons as coupon codes, promotional codes, promotion codes, discount codes, key codes, promo codes, surplus codes, portable codes, shopping codes, voucher codes, reward codes, discount vouchers, or source codes. These discounts can be wholesale, retail, or local. The discounts can be used for example, to receive discounts in restaurants, hotels, grocery stores, and retail shops.

These discounts may provide for reduced cost or free shipping, a specific dollar or percentage discount, or some other offer to encourage consumers to purchase specific products or to purchase from specific retailers. Typically, voucher codes are distributed for consumers to type in at checkout. According to the systems and methods describe herein, online retailers may offer special discounts to buyers buying in bulk. Thus, a buyer looking for wholesale deals may be able to receive better discounts for buying a greater quantity of the product.

The client devices 130, in some example embodiments, may include a Graphical User Interface (GUI). In a typical GUI, instead of offering only text menus or requiring typed commands, the system presents graphical icons, visual indicators or special graphical elements called widgets that may be utilized to allow the user 140 to interact with the internet directory interface 150. The client devices 130 may be configured to utilize icons used in conjunction with text, labels or text navigation to fully represent the information and actions available to users.

The client devices 130 may include a mobile telephone 132, a computer 134, a television (TV) set 136, and a personal digital assistant (PDA) 138. The user 140, in some example embodiments, is a person interacting with the internet directory interface 150 via the client devices 130. In some other embodiments, the user 140 may be represented by an automated process designed to simulate a person. The user 140 may be a buyer using the internet directory interface 150 to search for retail, wholesale, local, and reward coupons. The internet directory interface 150, in some example embodiments facilitate fast and efficient product search.

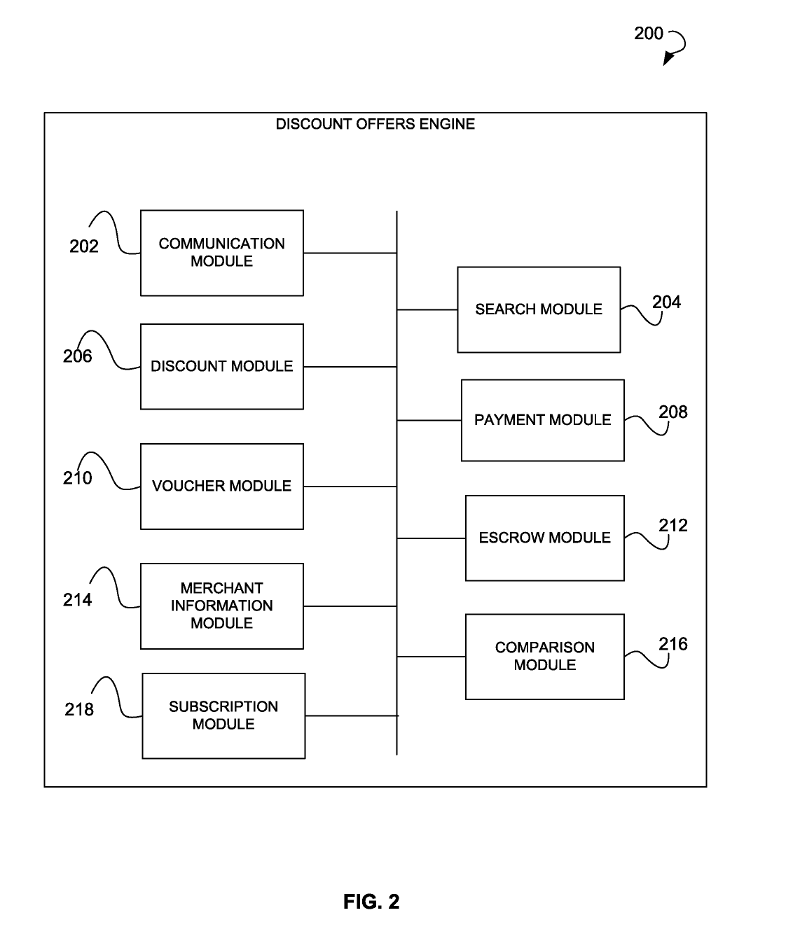

FIG. 2 illustrates a detailed block diagram of the discount offers engine 200, in accordance with an example embodiment. The discount offers engine 200 may include a communication module 202, a search module 204, a discount module 206, a payment module 208, a voucher module 210, an escrow module 212, a merchant information module 214, a comparison module 216, and a subscription module 218.

Note that even though various modules of the discount offers engine 200 shown together, the discount offers engine 200 may be implemented as a web service, via a distributed architecture, or within a cloud computing environment. The discounted offers engine 200 may be implemented with the context of wider electronic commerce, commonly known as e-commerce. The e-commerce may consist of the buying and selling of products or services over the network 110, for example, Internet and other computer networks. The e-commerce is more than just buying and selling products online. It may also include the entire online process of developing, marketing, selling, delivering, servicing and paying for products and services. Online shopping is a form of electronic commerce where the buyer is buying directly from the seller's website without an intermediary service. The sale and purchase transaction is completed electronically and interactively in real-time.

The communication module 202 of the discount offers engine 200 may be configured to receive, from user 140 via the user interface 150, a request to perform a search for one or more discount offers associated with a product based on certain search criteria. The search module 204 may be configured to find products which are available for sale on the web and can be purchased with a coupon. The search results may provide information such as product pictures, pricing, and description. Thus, the search module 204 may facilitate the products search based on specific search criteria and to provide search results. The search results may include one or more discount offers for the product.

The communication module 202 may be further configured to receive, from the user, a selection of a product from the search results, which may include a product quantity. The discounts provide by the merchant may be based on the product quantity. The discount module 206 may be configured to provide the user with a specific discount offer for the product, based on the selection. The discount offer may represent an electronic document that can be exchanged for a financial discount or rebate when purchasing a product. Customarily, coupons are issued by manufacturers of consumer packaged goods or by retailers, to be used in retail stores as a part of sales promotions. They are often widely distributed through the Internet and mobile devices such as cell phones. In addition, coupons can also be targeted selectively to regional markets in which price competition is great.

The payment module 208 may be configured to process a transaction associated with a purchase of the product with the specific discount. The payment functionality may include various means of payment, which facilitates acceptance of electronic payments for online transactions. E-commerce payment systems have become increasingly popular due to the widespread use of the internet-based shopping and banking. There are numerous payments systems available for online merchants. These include the traditional credit, debit and charge card but also new technologies such as digital wallets, e-cash, mobile payment and e-checks. Another form of payment system is allowing a 3rd party to complete the online transaction for you. These companies are called Payment Service Providers (PSP).

The voucher module 210 may be configured to send voucher codes to the user and the merchant upon finalizing of a transaction. A voucher can be entered when shopping online and the relevant vouchers value can added to the order. A voucher can take the form of a code. Many companies have opted to use voucher codes lately.

The escrow module 212 may be configured to provide an escrow to hold funds until a delivery of the product is confirmed, the funds being delivered to the merchant upon the confirmation. The escrow may include an arrangement made under contractual provisions between the buyer and the merchant, whereby an independent trusted third party (for example, discount offers engine operators) receives and disburses money and/or documents for the buyer and the merchant with the timing of such disbursement by the third party dependent on the fulfillment of contractually-agreed conditions. Thus, for example, the funds can be released to the merchant only on the condition of the delivery of the product to the buyer.

The merchant information module 214 may be configured to provide information associated with the merchant, which may include a name, a location, reputation, transaction history, and contact information. The comparison module 216 may be configured to compare values between from various merchants. On the internet, a price comparison service (also known as shopping comparison or price engine) allows users to see different lists of prices for specific products. Price comparison services typically do not sell products themselves but the discount offers engine 200 does. The comparison module 216 may collect data directly from merchants. Retailers, wholesalers, and local merchants who want to list their products on the website may supply their own lists of products and prices via the merchant interface of the discount offers engine 200.

Instead of having the merchants provide their products and prices, the comparison module 216 may crawl the web for prices. This means the comparison module 216 may scans retail, wholesaler, or local merchant web pages to retrieve the prices, instead of relying on the merchants to supply them.

Yet another approach taken by the comparison module 216 may include collecting data through crowdsourcing techniques. This approach may allow the price comparison engine to collect data from almost any source without the complexities of building a crawler or the logistics of setting up data feeds at the expense of lower coverage comprehensiveness. The discount offers engine may allow visitors to contribute pricing data. The subscription module 218 may be configured to provide a subscription to daily discount offers.

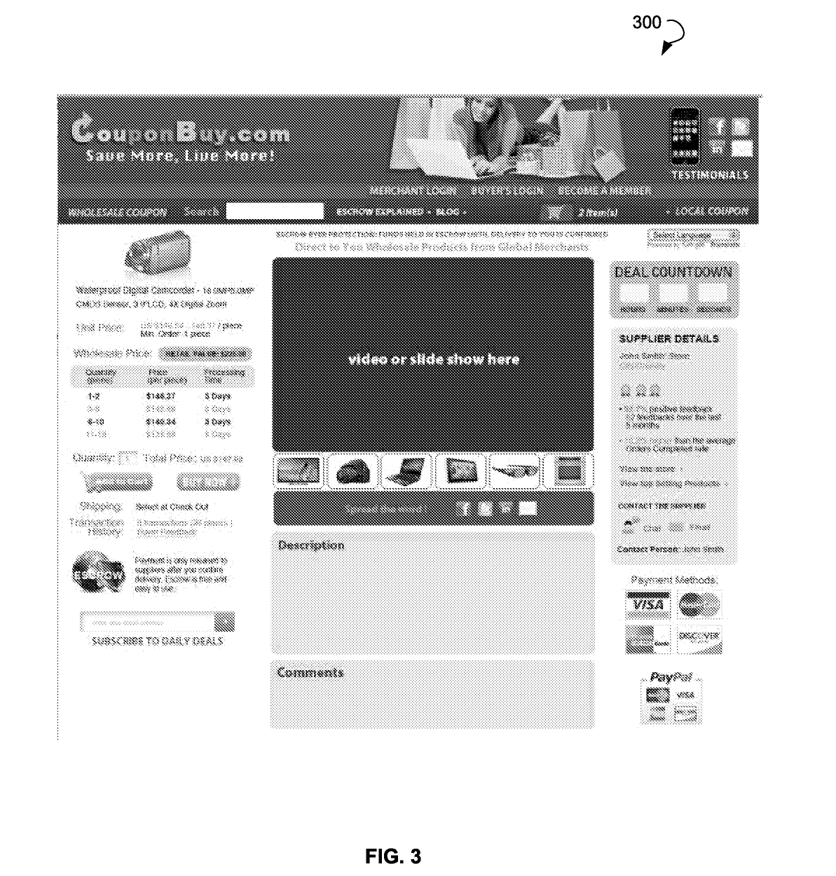

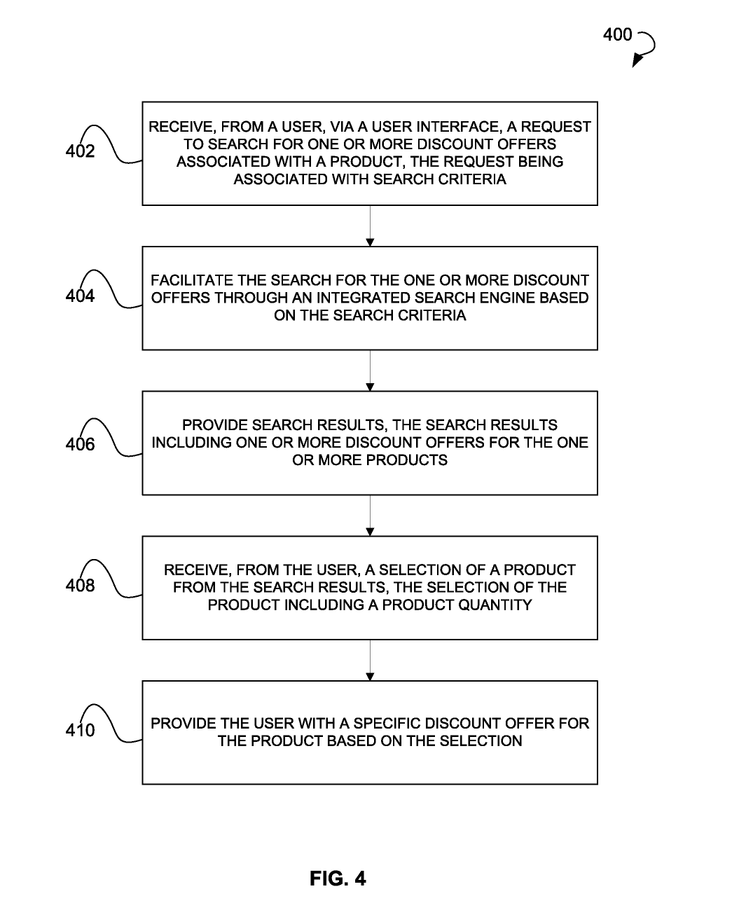

FIG. 3 is a screenshot of an internet directory interface 300, in accordance with an example embodiment. FIG. 4 shows a flow chart 400 of a method for providing discount offers via an internet directory interface, in accordance with an example embodiment. The method 400 may be performed by processing logic that may comprise hardware (e.g., dedicated logic, programmable logic, microcode, etc.), software (such as run on a general-purpose computer system or a dedicated machine), or a combination of both. In one example embodiment, the processing logic resides at the discount offers engine 200, illustrated in FIG. 2. The method 400 may be performed by the various modules discussed above with reference to FIG. 2. Each of these modules may comprise processing logic.

As shown in FIG. 4, the method 400 may commence at operation 402, with the communication module 202 receiving, from the user 140, via the user interface 150, a request to search for one or more discount offers associated with a product. The request may include search criteria. For example, the user may select a type of the discount including whether the discount is a wholesale discount, a local discount, a retail discount, and a reward coupon.

At operation 404, the search module 204 may facilitate the search for the discount offers through an integrated search engine based on the search criteria provided by the user 140. At operation 406, the search module 204 may provide search results, which may include discount offers for the products being search. The search results may include a value, a product quantity, an image, a video, and a price per unit, a countdown counter showing a time left to an expiration of the specific discount, and payment information. The price per unit may depend on the quantity of the product.

At operation 408, the communication module 202 may receive, from the user 140, a selection of a product from the search results. The selection may include a product quantity. Based on this selection the voucher module 210 may provide the user with a specific discount offer for the product.

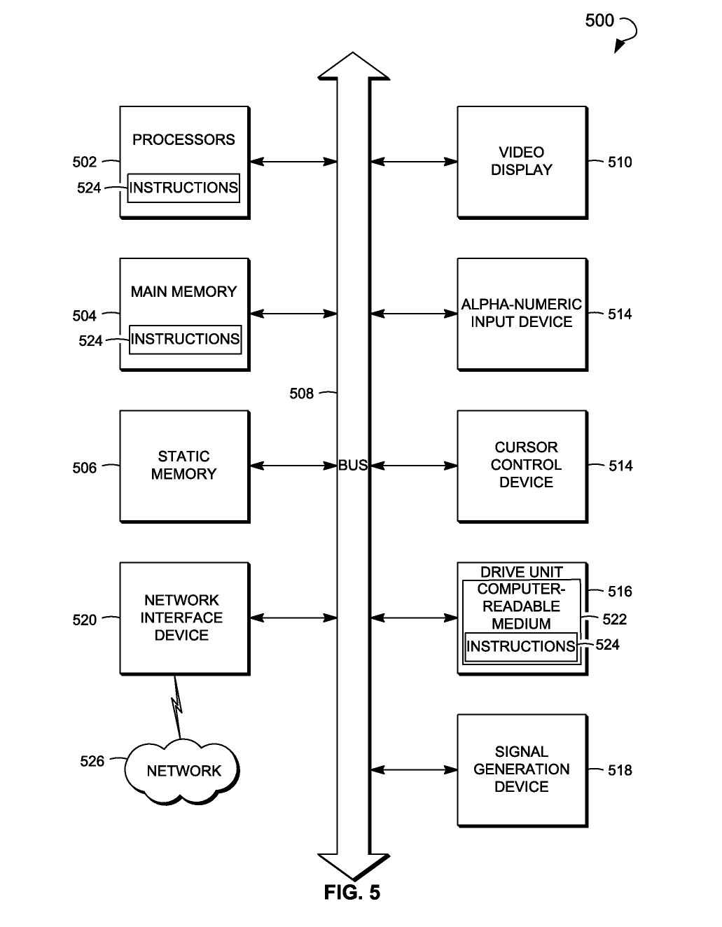

FIG. 5 shows a diagrammatic representation of a machine in the example electronic form of a computer system 500, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 500 includes a processor or multiple processors 502 (e.g., a central processing unit (CPU), a graphics processing unit (GPU), or both), a main memory 504 and a static memory 506, which communicate with each other via a bus 508. The computer system 500 may further include a video display unit 510 (e.g., a liquid crystal display (LCD) or a cathode ray tube (CRT)). The computer system 500 may also include an alphanumeric input device 512 (e.g., a keyboard), a cursor control device 514 (e.g., a mouse), a disk drive unit 516, a signal generation device 518 (e.g., a speaker) and a network interface device 520.

The disk drive unit 516 includes a computer-readable medium 522, on which is stored one or more sets of instructions and data structures (e.g., instructions 524) embodying or utilized by any one or more of the methodologies or functions described herein. The instructions 524 may also reside, completely or at least partially, within the main memory 504 and/or within the processors 502 during execution thereof by the computer system 500. The main memory 504 and the processors 502 may also constitute machine-readable media.

The instructions 524 may further be transmitted or received over a network 526 via the network interface device 520 utilizing any one of a number of well-known transfer protocols (e.g., Hyper Text Transfer Protocol (HTTP)).

While the computer-readable medium 522 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The example embodiments described herein may be implemented in an operating environment comprising software installed on a computer, in hardware, or in a combination of software and hardware.

Thus, a system and method for or providing discounts via an internet directory interface have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What is claimed is:

1. A method for providing discount offers via an internet directory interface, the method comprising:
receiving, from a user, via a user interface, a request to search for one or more discount offers associated with a product, the request being associated with search criteria;
facilitating the search for the one or more discount offers through an integrated search engine based on the search criteria;
providing search results, the search results including one or more discount offers for the one or more products;
receiving, from the user, a selection of a product from the search results, the selection of the product including a product quantity; and
based on the selection, providing the user with a specific discount offer for the product.

2. The method of claim 1, further providing a payment functionality to process a transaction associated with a purchase of the product with the specific discount from a merchant associated with the product, the payment functionality including one or more means of payment.

3. The method of claim 2, further comprising sending voucher codes to the user and the merchant.

4. The method of claim 2, further comprising providing an escrow to hold funds until a delivery of the product is confirmed, the funds being delivered to the merchant upon the confirmation.

5. The method of claim 2, further specify a processing time associated with the transaction.

6. The method of claim 2, where the purchase is direct from the merchant.

7. The method of claim 2, further comprising providing merchant information associated with the merchant, the merchant information including one or more of the following: a name, a location, reputation, transaction history, and contact information.

8. The method of claim 1, wherein the user selects a type of the discount, the type including one or more of the following: a wholesale discount, a local discount, a retail discount, and a reward coupon.

9. The method of claim 1, further comprising enabling a comparison between comparing values from various merchants.

10. The method of claim 1, further comprising providing information associated with the specific discount, the information including a value, a product quantity, an image, a video, and a price per unit, a countdown counter showing a time left to an expiration of the specific discount, and payment information

11. The method of claim 10, wherein the price per unit depends on the quantity of the product.

12. The method of claim 1, further comprising providing a subscription to daily discount offers.

13. A system for providing discount offers via an internet directory interface, the system comprising:
a communication module to receive, from a user, via a user interface, a request to perform a search for one or more discount offers associated with a product, the request being associated with search criteria;
a search module to facilitate the search for the one or more discount offers based on the search criteria and to provide search results, the search results including one or more discount offers for the one or more products, the communication module is further to receive from the user, a selection of a product from the search results, the selection of the product including a product quantity; and
a discount module to provide the user with a specific discount offer for the product, based on the selection.

14. The system of claim 13, further including a payment module to process a transaction associated with a purchase of the product with the specific discount from a merchant associated with the product, the payment functionality including one or more means of payment.

15. The system of claim 14, further including a voucher module to send voucher codes to the user and the merchant.

16. The system of claim 14, further including an escrow module to providing an escrow to hold funds until a delivery of the product is confirmed, the funds being delivered to the merchant upon the confirmation.

17. The system of claim 14, further including a merchant information module to provide information associated with the merchant, the merchant information including one or more of the following: a name, a location, reputation, transaction history, and contact information.

18. The system of claim 13, further including a comparison module to compare values between from various merchants.

19. The system of claim 13, further including a subscription module to provide a subscription to daily discount offers.

20. A computer-readable medium comprising instructions, which when executed by one or more processors, perform the following operations:
receive, from a user, via a user interface, a request to search for one or more discount offers associated with a product, the request being associated with search criteria;
facilitate the search for the one or more discount offers through an integrated search engine based on the search criteria;
provide search results, the search results including one or more discount offers for the one or more products;
receive, from the user, a selection of a product from the search results, the selection of the product including a product quantity; and
provide the user with a specific discount offer for the product based on the selection.
